(19) United States
(12) Patent Application Publication
(10) Pub. No.: US 2013/0248662 A1
(43) Pub. Date: Sep. 26, 2013

(54) CABLE ROUTING ARRANGEMENT

(71) Applicants: Tibor Herglotz, Kreuzau (DE); Ingo Steinfeld, Langenfeld (DE)

(72) Inventors: Tibor Herglotz, Kreuzau (DE); Ingo Steinfeld, Langenfeld (DE)

(73) Assignee: DR. HAHN GmbH & Co. KG, Moenchengladbach-Wickrath (DE)

(21) Appl. No.: 13/991,625

(22) PCT Filed: Oct. 31, 2011
(86) PCT No.: PCT/EP2011/069076

§ 371 Date: Jun. 5, 2013

(30) Foreign Application Priority Data
Dec. 6, 2010 (DE) 20 2010 013 064.6

(51) Int. Cl. F16L 5/00

(52) U.S. Cl. CPC F16L 5/00
USPC 248/71

(57) ABSTRACT

A cable routing arrangement includes at least one hollow profile comprising at least one perforation and a fastening surface and at least one of a first band part and a second band part. The first band part is configured to be fastened to the fastening surface. The first band part comprises at least one first cable routing duct. The at least one first cable routing duct comprises a first region configured to reach into the at least one hollow profile. The second band part is configured to be fastened to the fastening surface. The second band part comprises at least one second cable routing duct. The at least one second cable routing duct comprises a second region configured to reach into the at least one hollow profile.

### CROSS REFERENCE TO PRIOR APPLICATIONS

This application is a U.S. National Phase application under 35 U.S.C. §371 of International Application No. PCT/EP2011/069076, filed on Oct. 31, 2011 and which claims benefit to German Patent Application No. 20 2010 013 064.6, filed on Dec. 6, 2010. The International Application was published in German on Jun. 14, 2012 as WO 2012/076252 A1 under PCT Article 21(2).

### FIELD

The present invention relates to a cable routing arrangement comprising a hollow profile and a band part which can be fastened to a fastening surface of the hollow profile, and which has at least one cable-routing duct.

### BACKGROUND

Devices such as, for example, electric block locks, lock bars, switching and/or reed contacts, escape door openers, display units, etc., that are in particular used for door wings, usually require a line connection between the frame and the wing, for example, for providing an energy supply to these devices and/or data transmission between a control or a regulation unit in the building and the devices in the wing.

These lines are usually electric cables. The present invention is, however, not limited thereto, but relates to all lines that are required for the respective intended use. Examples include fiber optic cables, tubes and hydraulic lines.

Cable duct transitions have been described wherein a cable outlet on the door wing side is connected to a cable outlet on the frame side by means of a flexible metal tube in order to feed the lines from the fixed frame to the wing that is pivotably fastened to the frame by means of bands.

Through the cable outlet on the wing side, the cable is inserted into the flexible metal tube, at the other end of which the cable exits again through the cable outlet on the frame side. Between the two cable outlets, the metal tube is visible from one side of the door, which, of course, also applies to the two cable outlets. This results in a disturbance of the overall visual impression of the door and an increased risk of manipulation since, by simply cutting through the flexible metal tube containing the cable, the line connection in devices provided in the wing can be disconnected.

DE 20 2006 016 439 U1 describes a device for connecting lines which extend between a fixed frame and a wing that is pivotable about a hinge axis by means of bands comprising frame and wing band parts fastened to the wing. This device has a connector that is connected to the lines and comprises two parts, which parts, by shifting the wing from the frame in the direction toward the hinge axis, can be detached so as to be disconnected, or the lines can be brought together so as to be operatively connected. The frame as well as the wing can thereby be prepared with the associated band parts and the parts of the connector. Establishing the operative connection then takes place automatically when the wing (as usual) is mounted by sliding the wing band parts onto the band pin defining the hinge axis (in other words: by hanging).

DE 20 2006 016 439 U1 describes matching the outer shape of this device with the outer shape of the bands used for pivotably fastening the wing to the frame so that the device visually appears as an additional band.

Many of the known band arrangements are configured to provide the possibility to shift the wing in the frame in the direction of the hinge axis as well as perpendicular thereto for the purpose of adjusting the wing. The connector of the device described in DE 20 2006 016 439 U1 is accordingly configured to allow this shifting of the wing in the frame for adjusting purposes while maintaining the operative connection. The one part of the connector is thereby arranged to be shiftable in the direction perpendicular to the hinge axis, and the other part of the connector is arranged to be shiftable in the direction of the hinge axis.

A disadvantage of this arrangement is that shifting the wing relative to the frame results in an offset between the wing part and the band part of the device. The visual impression given hereby is in particular adversely influenced in those cases in which displacing the bands carrying the wing takes place by shifting the fastening parts of their band straps relative to the frame or the wing, and thus no offset of the band straps of a band relative to one another takes place.

Unpublished DE 20 2010 008 551.9 describes an arrangement in which the band part is fastened to the fastening surface of the hollow profile so as to be floatable at least in one spatial direction, usually in all spatial directions in which the bands provided for pivotably fastening the wing to the frame allow a displacement for adjusting purposes. Adjusting the wing in the frame is hereby possible without shifting the band part fastened to the wing and the band part fastened to the frame relative to one another. A disadvantage here is that a gentle transition of the cable from the band part into the hollow profile and protection of the cable when shifting the wing in the frame, in particular for adjusting the wing, is not provided under all circumstances.

### SUMMARY

An aspect of the present invention is to provide an improved cable routing arrangement.

In an embodiment, the present invention provides a cable routing arrangement which includes at least one hollow profile comprising at least one perforation and a fastening surface and at least one of a first band part and a second band part. The first band part is configured to be fastened to the fastening surface. The first band part comprises at least one first cable routing duct. The at least one first cable routing duct comprises a first region configured to reach into the at least one hollow profile. The second band part is configured to be fastened to the fastening surface. The second band part comprises at least one second cable routing duct. The at least one second cable routing duct comprises a second region configured to reach into the at least one hollow profile.

### BRIEF DESCRIPTION OF THE DRAWINGS

The present invention is described in greater detail below on the basis of embodiments and of the drawings in which:

FIG. 1 shows a perspective illustration of an arrangement described in the prior art which is visually based on a three-piece band, with the band part not yet mounted on the hollow profile;

FIG. 2 partially shows the band part according to FIG. 1 in an individual illustration from behind;

FIG. 3 shows the arrangement according to FIG. 1 in the mounted state;

FIG. 4 shows a section in the plane IV-IV in FIG. 3;

FIG. 5 shows the section V in FIG. 4 in an enlarged, individual illustration;

FIGS. 6a) and b) show a fastening element known from the prior art in a perspective individual view and a view on the narrow side;

FIG. 7 shows a perspective illustration of the arrangement according to the present invention that is visually based on a three-piece band, without covers;

FIG. 8 shows an image as in FIG. 1 in a partially exploded view;

FIG. 9 shows an illustration of a section along the line III-III in FIG. 1;

FIG. 10 shows a sectional illustration along the line IV-IV in FIG. 1;

FIG. 10a shows the cut-out in FIG. 10 in an enlarged individual illustration;

FIG. 11 shows a sectional illustration along the line V-V in FIG. 1;

FIG. 12 shows a sectional illustration along the line VI-VI, without a cable;

FIG. 13 shows a perspective illustration of the arrangement according to the present invention with covers in a typical application;

FIG. 14 shows an illustration as in FIG. 13 without covers and without hollow profiles;

FIG. 15 shows a perspective illustration of a cut-out of the arrangement according to the present invention with view on that side of the arrangement that faces toward the fastening side and focus on the wing band part;

FIG. 16 shows an illustration as in FIG. 9 with focus on the upper region of the frame band part;

FIG. 17 shows a partial perspective illustration of the arrangement according to the present invention with a view on the side facing away from the fastening surface and focus on the upper region of the frame band part.

### DETAILED DESCRIPTION

The cable routing arrangement according to the present invention comprises at least one hollow profile which has at least one perforation. The arrangement further comprises a first band part which can be fastened to a fastening surface of the hollow profile and which has at least one first cable-routing duct and/or a second band part which can be fastened to a fastening surface of the hollow profile and which has at least one second cable-routing duct. The at least one first duct has a first region that reaches into the hollow profile and/or the at least one second duct has a second region that reaches into the hollow profile.

In this manner, the cable is protected against, for example, sharp bore edges of the perforation in the hollow profile.

If in connection with the arrangement according to the present invention “band parts” are mentioned, this does not mean that these parts transmit holding forces between the frame and the wing. Arrangements that only serve to transmit (for example, electrical) energy between the frame and the wing are also included.

In an embodiment of the present invention, a plurality of ducts and a plurality of perforations can, for example, be provided.

In an embodiment of the present invention, the region reaching into the perforation can, for example, be formed by a component that is separate from the band part and, for example, also separate from the remaining duct in the band part.

In an embodiment of the present invention, the first band part can, for example, be floatingly fastened to the fastening surface. This means that the band part is held on the fastening surface and secured against removing; however, shifting relative to the fastening surface is possible without requiring particular measures such as untightening fasteners.

The diameter of the first region reaching into the hollow profile is smaller than the diameter of the perforation. This provides that the first region does not impede displaceability, in particular, caused by adjusting the wing, of the first band part relative to the fastening surface.

In an embodiment of the present invention, the cable passes inside the hollow profile through webs running in the hollow profile in close proximity to the band part. The first region reaching into this hollow profile in this embodiment can, for example, have a length so that these webs, which run inside the hollow profile and through which the cable passes, are penetrated by the first region. The cable thus passes through these webs inside the first duct. In this manner, the cable is also protected against damage caused by the webs of the hollow profile.

In an embodiment of the present invention, the first region can, for example be formed by a cable bushing.

In an embodiment of the present invention, the second band part can, for example, be fixedly fastened to the fastening surface of the hollow profile. The diameter of the second region reaching into the hollow profile can, for example, correspond at least approximately to the diameter of the perforation. In this manner, the second region reaching into the hollow profile, in addition to the protective function for the cable, can also assume fastening functions for the second band part. Since displaceability of the second band part relative to its fastening surface is prevented in this manner, this embodiment is in particular suitable for use for a second band part which interacts with a first band part, the displaceability of which relative to the fastening surface is not prevented. In an embodiment of the present invention, the second region reaching into the hollow profile can, for example, be formed by a centering sleeve.

It is conceivable that the cable bushings comprise plastics and the centering sleeves comprise metal.

In an embodiment of the present invention, the arrangement can, for example, comprise a wing band part and a frame band part. The wing band part can, for example, comprise the first band part and the frame band part can, for example, comprise the second band part. Both band parts can, for example, have two cable-routing ducts in each case.

In an embodiment of the present invention, the perforation can, for example, also be suitable for receiving fasteners for a band carrying the wing. Implementing the perforation in the hollow profile can then be carried out with tools which have to be provided anyway for mounting the bands effecting the pivotable fastening.

An embodiment of an arrangement described in the prior art, as a whole designated by 100, comprises a hollow profile 1 which is designed as a multi-chamber profile having isolating webs 4, 5 (see FIG. 4) separating the chambers 2, 3 from one another.

The hollow profile 1 comprises two perforations 6, 7 which, with regard to their position in the hollow profile and to their diameter, correspond to such perforations that serve for receiving fastening elements for mounting a band (not shown in the drawings) effecting a pivotably movable connection of the hollow profile 1 on a frame profile 8.

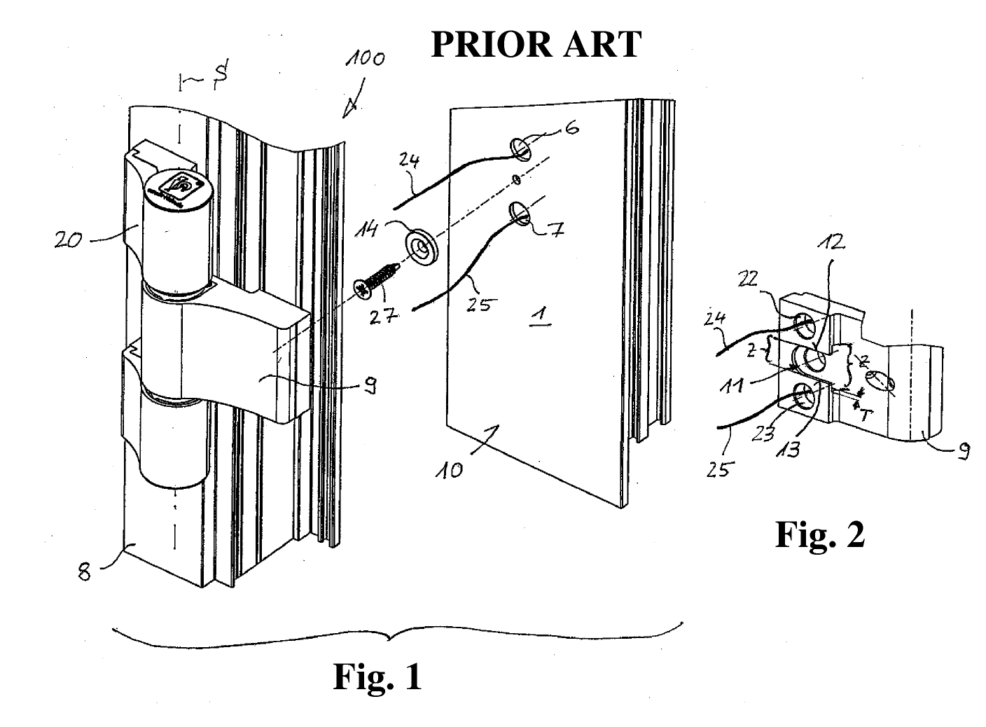

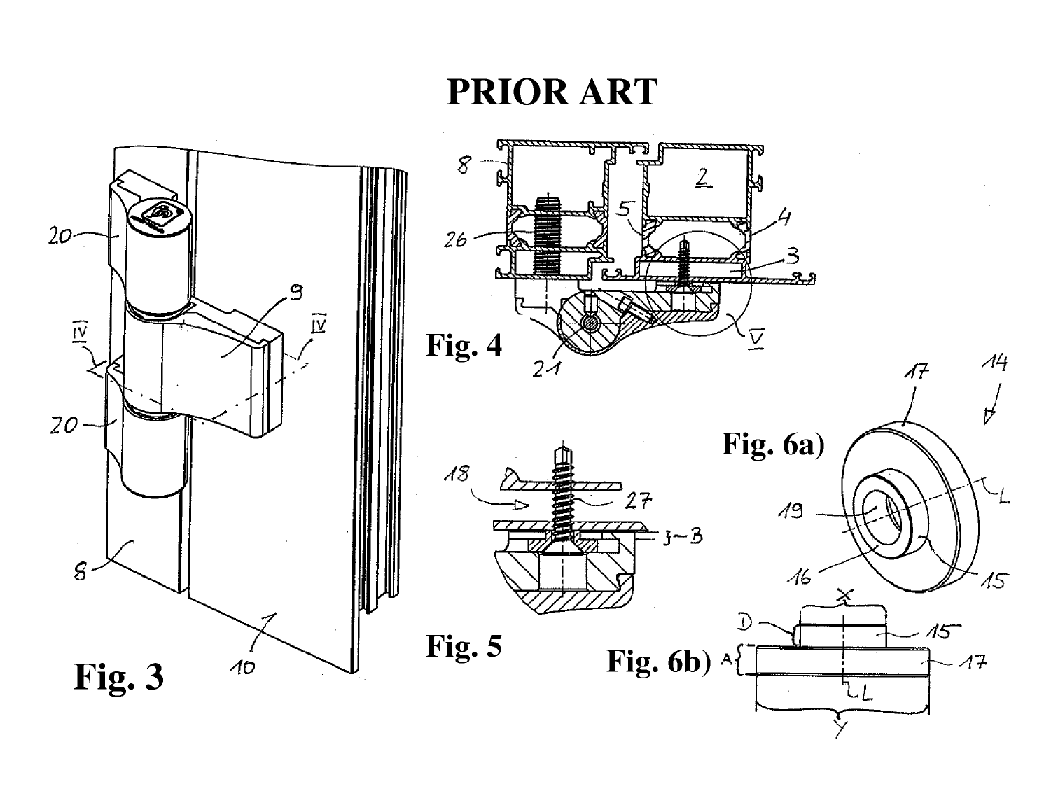

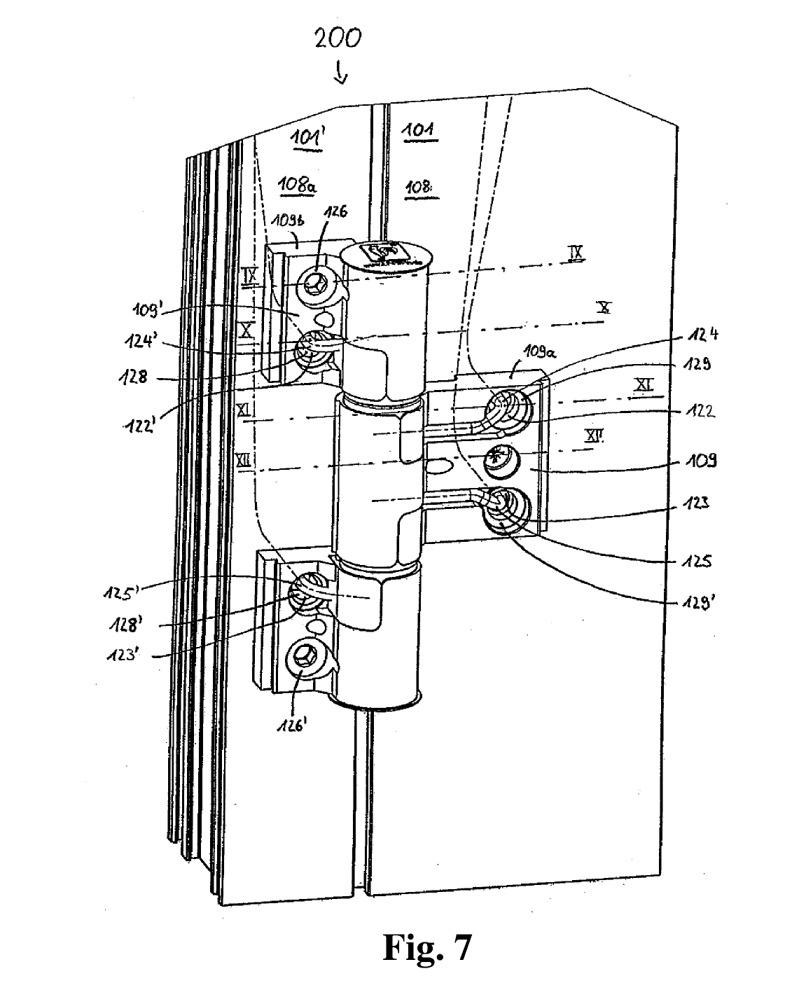

The arrangement 100 furthermore comprises a band part 9 that is floatingly fastened in FIG. 1 and FIG. 3 on a fastening surface 10 of the hollow profile 1, which fastening surface faces obliquely toward the viewer.

In order to implement this floating fastening, the band part 9 comprises a groove 11 with an undercut that is open toward the fastening surface 10, the undercut of which groove is formed by two projections 12, 13 that face one another and run parallel to the fastening surface 10.

As shown in FIG. 2, the groove 11 is open toward the pivot axis S.

A fastening element 14 serves for engaging in the groove of the band part 9 which is illustrated in detail in FIGS. 6a and b). The fastening element 14 is formed rotationally symmetric about a longitudinal center axis L and comprises a base 15 which rests with its end face 16 against the fastening surface 10. The base 15 has a thickness D that is slightly larger than the thickness B of the projections 12 and 13 (see FIG. 5). The diameter X of the base 15 is smaller than the inner width Z between the two projections 12, 13. The fastening element 14 engages in the undercut, formed by the projections 12 and 13, of the groove 11 with a collar 17 which is formed onto the base 15 and the diameter Y of which is smaller than the groove width Z and the thickness A of which is smaller than the groove depth T.

A fastening means 18 serves for fastening the fastening element 14 which is designed as a self-drilling and self-cutting screw 27 which penetrates the fastening element 14 in a central bore 19 and by tightening of which the end face 16 can be clamped against the fastening surface 10. Due to the clearance of the fastening element 14 in the groove 11, the band part 9 can be slid onto the fastening element, after the latter is mounted, and can be hingedly connected to another band part 20, for example by means of a pin 21 defining the pivot axis S.

In that side of the band part 9 that faces the fastening surface 10, ducts 22, 23 are incorporated which are approximately aligned with the perforations 6, 7 of the hollow profile. Cables run through the perforations 6, 7, the diameter of the cables being smaller than the diameters of the perforations 6, 7 and/or the channels 22, 23. Due to the diameter difference, the band part can shift within the circumference of the clearance between the fastening element 14 and the groove 11 relative to the fastening surface without clamping the cables 24, 25.

In a simple constructional manner, a cable routing arrangement is thus provided which allows adjusting the wing in the frame, for example, by means of known three-dimensional adjustable bands without further measures.

In order that the arrangement 100 known from the prior art cannot shift uncontrolled out of the mounting position illustrated in the drawing, the band part 20, with which the band part 9 is pivotably connected via the pin 21, is screwed in a conventional manner to the profile 8 with fastening screws 26 (see FIG. 4). However, if needed, the band part 20 can also be fastened in a floating manner.

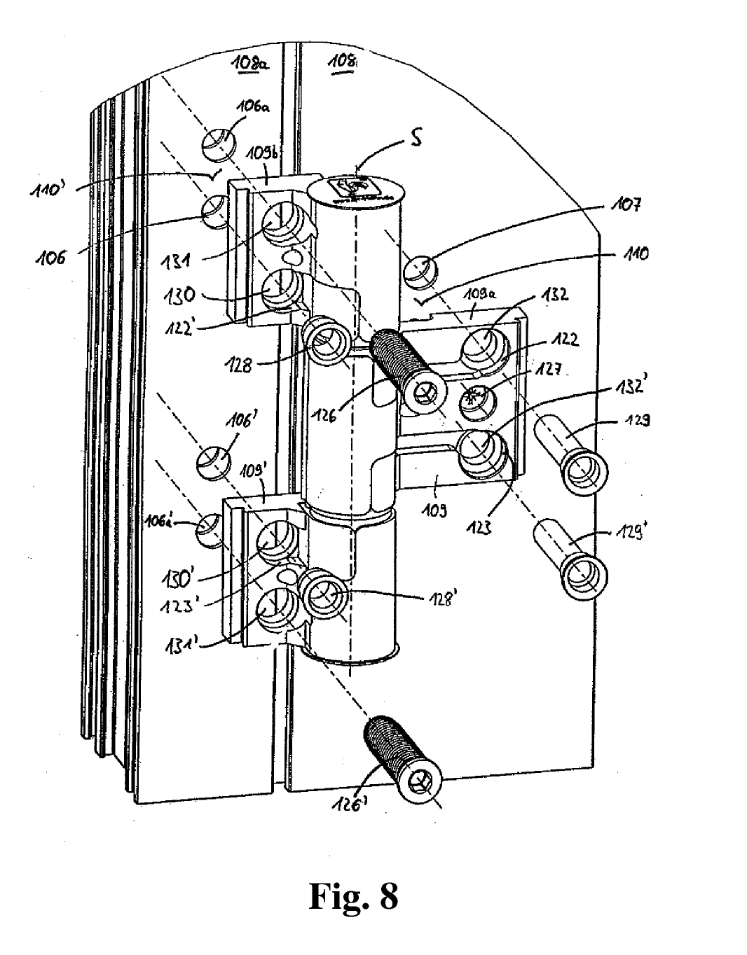

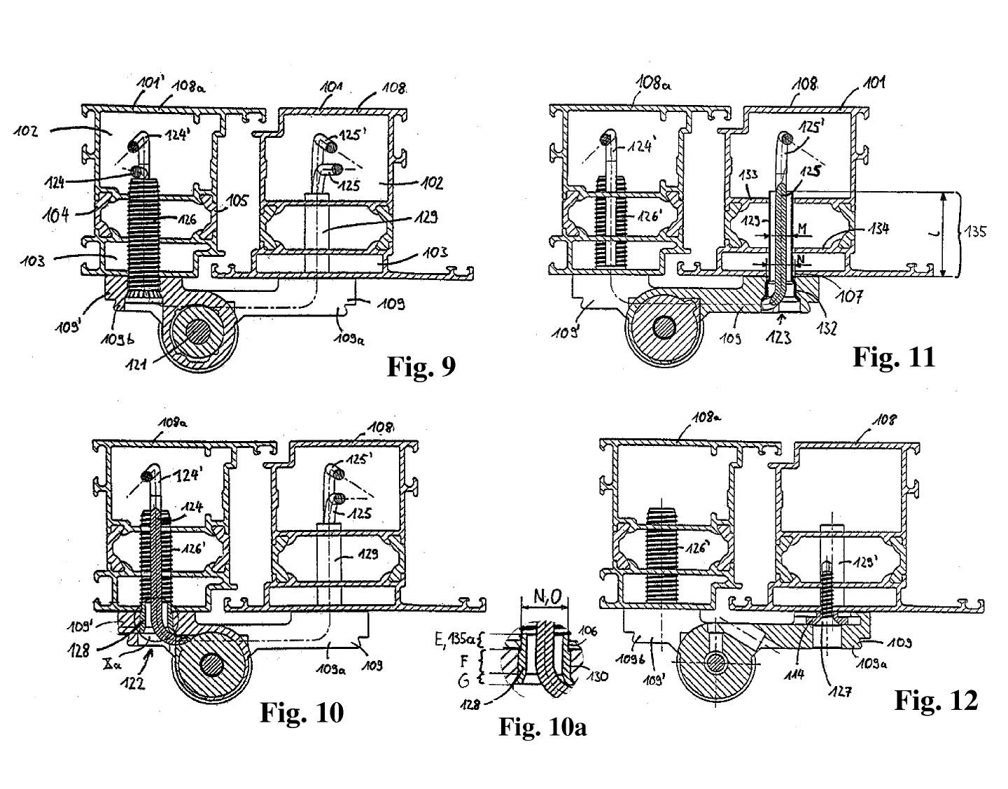

The exemplary embodiment of an arrangement according to the present invention, as a whole designated by 200 in the drawings, comprises two hollow profiles 101, 101′ which are formed as multi-chamber profiles having chambers 102, 103 separated from one another by isolating webs 104, 105. A hollow profile 101 is part of a wing (wing profile 108), and the other hollow profile 101′ is part of a frame (frame profile 108a). The wing profile 108 comprises two perforations 107 of which in FIG. 8 only the upper one is visible, and which, with regard to their position in the wing profile and to their diameter, correspond to such perforations that serve for receiving fastening elements for mounting a band that carries the wing. Both of these perforations 107 serve for cable routing. The frame profile 108a comprises four perforations 106, 106′, 106a, 106a′ which, with regard to their position in the frame profile and to their diameter, likewise correspond to such perforations that serve for receiving fastening elements for mounting a band (not illustrated in the drawings) that carries the wing. In two of these perforations 106a, 106a′, fastening screws 126, 126′ are inserted. The remaining two perforations 106, 106′ serve for cable routing.

The arrangement according to the present invention comprises a first band part 109 and a second band part 109′. The two band parts 109, 109′ are connected to one another, for example, via a pin 21 defining the pivot axis S. The first band part 109 is floatingly fastened to the wing profile and thus forms the wing band part 109a. The floating fastening is carried out by means of, among other things, a fastening element 114 on the fastening surface 110, in the same manner as in the case of the above-described band part 9 known from the prior art.

The second band part 109′ is fixedly fastened to the frame profile 108a (frame band part 109b).

The wing band part 109a has two first ducts 122, 123 which extend through the perforations 107 into the wing profile 108. The frame band part 109b has two second ducts 122′, 123′ which extend through the perforations 106, 106′ into the frame profile 108a.

In the frame band part 109b, the second ducts 122′, 123′ comprise bores 130, 130′ that transition into centering sleeves 128, 128′ which are inserted into the bores 130, 130′. Each centering sleeve 128, 128′ extends the duct 122′, 123′ situated in the frame band part up into the hollow profile (see FIG. 10). Each centering sleeve 128, 128′ has three regions E, F, G (see FIG. 10a). The region E penetrates the perforation 106, 106′ of the frame profile 108a and forms the second region 135a that extends into the hollow profile 101′. The region E has an outside diameter O that corresponds at least approximately to the diameter N of the perforation 106, 106′ of the frame profile 108a. The region F adjoining the region E differs from the latter in that it has a slightly larger outside diameter which corresponds at least approximately to the diameter of the cable-routing bore 130, 130′ in the frame band part in which the centering sleeve 128, 128′ is inserted. In the region G adjoining the region F, the centering sleeve 128, 128′ widens slightly so that its outer contour rests against the widening cable-routing bore 130, 130′ in the frame band part. The centering sleeves 128, 128′ fulfill a plurality of tasks. On the one hand, they serve for fastening the frame band part 109b by counteracting twisting of the frame band part. This is in particular important if the arrangement is not based on a three-piece band design, as shown, but on a two-piece band design (not shown). On the other hand, they guide the cables 124′, 125′ running therethrough and protect them in particular against the edges of the perforations 106, 106′. The fastening of the frame band part 109b thus represents a fastening combination of fastening screws 126, 126′ (e.g. anchor screws) as a direct fastening for screwing the frame band part to the frame profile 108a, and the centering sleeves 128, 128′.

In the wing band part 109a, the first ducts 122, 123 comprise bores 132, 132′ that transition into cable bushings 129, 129′ that are inserted into the bores 132, 132′. As is in particular shown in FIG. 11, the regions of the cable bushings that are arranged in the bores 132, 132′ are adapted to the course of the bores in a similar manner as the centering sleeves 128, 128′. FIG. 11 also shows that the cable bushings 129, 129′ have a first region 135 which extends into the inside of the hollow profile 101 and which has such a length I that the webs 133, 134, which run inside the hollow profile and through which the cable 125 passes, are penetrated. The diameter M of the first region 135 is significantly smaller than the diameter N of the perforation 107.

The cable-routing bores 130, 130′, 132, 132′ in the two band parts 109a, 109b have the same position, form and size as the bores that are provided for receiving the fastening screws.

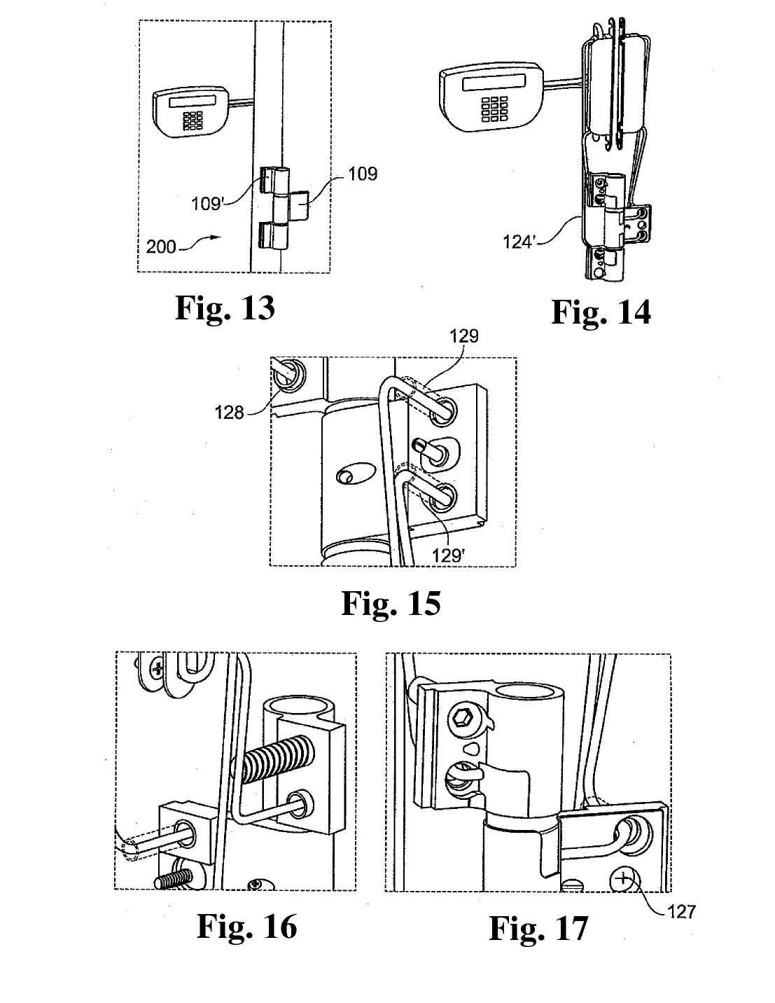

Running through the frame band part 109b are a cable 124′ which is in electrical operative connection with a cable 124 that runs through the wing band part 109a, and a further cable 125′ running therebelow which is in electrical operative connection with a further cable 125 running below the cable 124 through the wing band part. The cable 124′ runs in the inside of the frame profile 108a, through the centering sleeve 128 and the further second channel 122′ of the frame band part 109b up to the electrical operative connection with the cable 124. In the wing band part 109a, the cable 124 runs through the first duct 122 and the cable bushing 129 into the inside of the wing profile 108. The lower cables 125′ and 125 run correspondingly. If the covers are arranged on the band parts, as in FIG. 13, the cables are invisible from the outside.

The arrangement according to the present invention can be used on right- and left-hinged wings. Shifting the wing in the frame, in particular, by displacing or adjusting the bands carrying the wing, is enabled by the arrangement and has no negative effect on the cables or their durability. Used are the perforations 106, 106′, 107 which already exist or can be implemented with existing tools in the hollow profiles. For the wing band part 109a, no conventional fastening means are required. The arrangement can be mounted in a very simple manner, can be retrofitted, is extremely cost-effective and can be used for all frame materials.

The present invention is not limited to embodiments described herein; reference should be had to the appended claims.

### REFERENCE LIST

100, 200 Arrangement
1, 101, 101′ Hollow profile
2, 102 Chamber
3, 103 Chamber
4, 104 Isolating web
5, 105 Isolating web
6, 106, 106′ Perforation
106a, 106a′ Perforation
7, 107 Perforation
108 Wing profile
8, 108a Frame profile
9 Band part
109 First band part
109′ Second band part
109a Wing band part
109b Frame band part
10, 110, 110′ Fastening surface
11 Groove
12 Projection
13 Projection
14, 114 Fastening element
15 Base
16 End face
17 Collar
18 Fastening means
19 Bore
20 Band part
21, 121 Pin
22, 23 Duct
122, 123 First duct
122′, 123′ Second duct
24, 124 Cable
25, 125 Cable
124′, 125′ Cable
26, 126, 126′ Fastening screws
27, 127 Screw
128, 128′ Centering sleeve
129, 129′ Cable bushing
130, 130′ Cable-routing bores
131, 131′ Fastening bores
132, 132′ Cable-routing bores
133 Web
134 Web
135 First region
135a Second region
A Thickness
B Thickness
D Thickness
E Region
F Region
G Region
M Diameter
N Diameter
0 Diameter
L Longitudinal center axis
I Length
S Pivot axis
T Groove depth
X Diameter
Y Diameter
Z Groove width

1-8. (canceled)

9. A cable routing arrangement comprising:
at least one hollow profile comprising at least one perforation and a fastening surface; and at least one of:
a first band part configured to be fastened to the fastening surface, the first band part comprising at least one first cable routing duct, the at least one first cable routing duct comprising a first region configured to reach into the at least one hollow profile, and
a second band part configured to be fastened to the fastening surface, the second band part comprising at least one second cable routing duct, the at least one second cable routing duct comprising a second region configured to reach into the at least one hollow profile.

10. The cable routing arrangement as recited in claim 9, wherein the first region comprises a first region diameter and the at least one perforation comprises a perforation diameter, the first region diameter being smaller than the perforation diameter.

11. The cable routing arrangement as recited in claim 9, further comprising a cable and at least one web, the at least one web being arranged to run inside the at least one hollow profile and being configured to have the cable pass therethrough, wherein the first region comprises a length so that the at least one web is penetrated.

12. The cable routing arrangement as recited in claim 9, wherein the first region is formed by a cable bushing.

13. The cable routing arrangement as recited in claim 9, wherein the second region comprises a second region diameter, and the at least one perforation comprises a perforation diameter, the second region diameter corresponding approximately to the perforation diameter.

14. The cable routing arrangement as recited in claim 13, wherein the second region is formed by a centering sleeve.

15. The cable routing arrangement as recited in claim 9, further comprising a wing band part and a frame band part, wherein the wing band part comprises the first band part and the frame band part comprises the second band part.

16. The cable routing arrangement as recited in claim 9, further comprising a wing, a fastening device and a band, wherein the band is configured to carry the wing, and the at least one perforation is configured to receive the fastening means for the band.
